(19) United States
(12) Patent Application Publication
(10) Pub. No.: US 2010/0033702 A1
(43) Pub. Date: Feb. 11, 2010

(54) Coated mirrors and their fabrication

(75) Inventor: Valentino Rigato, Padova (IT)

Correspondence Address: OPTICUS IP LAW, PLLC, 7791 ALISTER MACKENZIE DRIVE, SARASOTA, FL, 34240, US

(73) Assignee: MEDIA LARIO S.R.L, Bosisio Parini (LC) (IT)

(21) Appl. No.: 12/311,767

(22) PCT Filed: Oct. 15, 2007
(86) PCT No.: PCT/EP2007/008935

§ 371 Date: Apr. 10, 2009

(30) Foreign Application Priority Data
Oct. 13, 2006 (IT) PCT/IT2006/000735

(51) Int. Cl. G03B 27/70; G02B 5/08; G02B 1/02; B05D 5/06

(52) U.S. Cl. 355/67; 359/359; 427/162; 977/832; 977/834

(57) ABSTRACT

(A1) A method of fabricating a mirror for EUV applications, comprising: (a) providing a substrate; (b) depositing a first layer on the substrate, the first layer being of nanometre scale or atomic layer thickness t1; (c) depositing a second layer on the first layer, the second layer being of nanometre scale or atomic layer thickness t2; wherein the first and second layers are deposited with different growth parameters, so as to have different structures and physical properties, and wherein each layer forms, alone or with an adjacent layer, an EUV reflective element, thereby forming a mirror with a substantially stress free micrometer scale thickness coating resistant to erosion by fast debris particle from an EUV source. Also disclosed is a collector optical system for extreme ultraviolet (EUV) or X-ray applications, including lithography and imaging, in which the mirror is used, and an EUV lithography system comprising: a radiation source, for example a LPP source, the collector optical system; an optical condenser; and a reflective mask.

The present invention relates to materials for optical systems, and more particularly to coated mirrors, for example for collector optics for EUV lithography, and to processes for their fabrication.

A well known optical design for X-ray applications is the type I Wolter telescope. The optical configuration of type I Wolter telescopes consists of nested double-reflection mirrors operating at grazing incidence.

More recently, a variation of the type I Wolter design already proposed for other applications, in which the parabolic surface is replaced by an ellipsoid, has found application for collecting the radiation at 13.5 nm emitted from a small hot plasma used as a source in Extreme Ultra-Violet (EUV) microlithography, currently considered a promising technology in the semiconductor industry for the next generation lithographic tools. Here, there is a performance requirement to provide a near constant radiation energy density or flux across an illuminated silicon wafer target at which an image is formed. The hot plasma in EUV lithography source is generated by an electric discharge (Discharge Produced Plasma or DPP source) or by a laser beam (Laser Produced Plasma or LPP source) on a target consisting of Lithium, Xenon, or Tin, the latter apparently being the most promising. The emission from the source is roughly isotropic and, in current DPP sources, is limited by the discharge electrodes to an angle of about 60° or more from the optical axis. EUV lithography systems are disclosed, for example, in US2004/0265712A1, US2005/0016679A1 and US2005/0155624A1.

A simplified block diagram of an EUV lithography system is shown in FIG. 1 (PRIOR ART). The ultra-violet source 102 is normally a hot plasma the emission of which is collected by the collector 104 and delivered to an illuminator 106. The latter illuminates a mask or reticle 108 with the pattern to be transferred to the wafer 110. The image of the mask or reticle is projected onto the wafer 110 by the projection optics box 112.

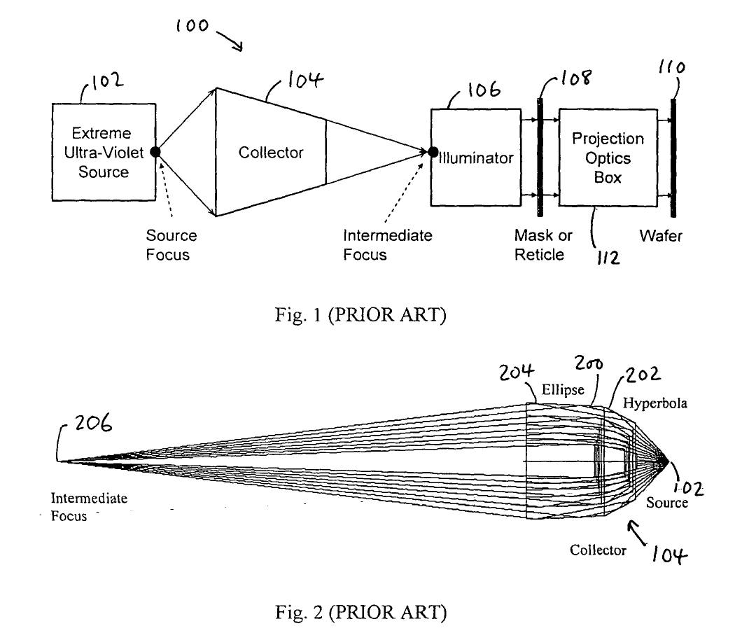

Presently, the most promising optical design for collectors 104 is based on nested Wolter I configuration, as illustrated in FIG. 2 (PRIOR ART). Each mirror 200 is a thin shell consisting of two sections (surfaces) 202, 204: the first one 202, closer to the source 102 is a hyperboloid whereas the second 204 is an ellipsoid, both with rotational symmetry, with a focus in common.

The light source 102 is placed in the focus of the hyperboloid different from the common focus. The light from the source 102 is collected by the hyperbolic section 202, reflected onto the elliptic section 204 and then concentrated to the focus of the ellipsoid, different from the common focus, and known as intermediate focus (IF) 206.

From an optical point of view, the performance of the collector 102 is mainly characterized by the collection efficiency and the far field intensity distribution. The collection efficiency is the ratio between the light intensity at intermediate focus 206 and the power emitted by the source 102 into half a sphere. The collection efficiency is related to the geometry of the collector 104, to the spatial and angular distribution of the source 102, to the optical specifications of the illuminator and, to the reflectivity of each mirror 200.

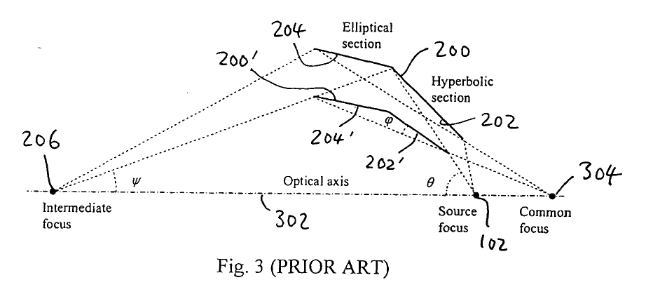

Referring to FIG. 3 (PRIOR ART), in the design of a Wolter I mirror the hyperbolic 202 and the elliptical section 204 has a focus in common (304) that lays on the optical axis 302 (i.e. the line through the source focus 102 and the intermediate focus 206).

For a given maximum collection angle on the source side, the collector efficiency is mainly determined by collected angle and by the reflectivity of the coating on the optical surface of the mirrors. At a given incidence angle, for the EUV radiation the reflectivity of the mirror depends on the physical properties of the first few nanometres of the mirror surface. The local surface composition, packing density and roughness determines the mirror performance and must be preserved or improved with time during exposure to the light source and its debris.

A problem with collector components is that the mirrors/coatings are thin and lack mechanical stability, under variable thermal loads.

A further problem is that, with the collector efficiencies available, there is imposed the need to develop extremely powerful sources, and to have high optical quality and stability in the collector.

A further problem is that mirrors/coatings lack durability, especially with respect to harsh cleaning regimes, e.g. using hydrogen and halogen chemistry at temperatures ranging from room temperature to several hundreds degrees Celsius, to remove condensable materials like (but not limited to) Sn or Li used in EUV source technology.

A further problem is that reflecting coatings lack durability with respect to intense debris damage due to fast charged ions and neutral particles (eg. Li, Sn, Xe) of kinetic energy in the range from few tens eV to several keV, emitted from the high power source operated with a sub-optimal debris suppression system. This may cause position dependent erosion of the optical material and alter the surface composition during exposure. As a consequence, both mirror performance and lifetime are deteriorated.

Therefore, one problem is that the collector lifetime may be relatively short due to exposure to extremely powerful source. This requires much thicker optical layers, with thickness of order of the micrometer or several micrometer, to withstand erosion.

A further problem is that, during the abovementioned erosion, the properties of the few-nanometers thick optically active surface need to be preserved or enhanced.

The present invention seeks to address the aforementioned and other issues.

According to one aspect of the present invention there is provided a method of fabricating a mirror for EUV applications, comprising: (a) providing a substrate; (b) depositing a first layer on the substrate, the first layer being of nanometre scale or atomic layer thickness t1; (c) depositing a second layer on the first layer, the second layer being of nanometre scale or atomic layer thickness t2; wherein the first and second layers are deposited with different growth parameters, so as to have different structures and physical properties; and wherein each layer forms, alone or with an adjacent layer, an EUV reflective element, thereby forming a mirror with a substantially stress free micrometer scale thickness coating resistant to erosion by fast debris particle from an EUV source

The physical properties may comprise one or more of density, crystal structure and intrinsic stress.

The thickness t1 may be such that 10⁻¹⁰ m≦t1<10⁻⁸, 10⁻¹⁰ m≦t1<10⁻⁷ m, 10⁻¹⁰ m≦t1<10⁻⁶, 10⁻⁹ m≦t1<10⁻⁸ m, or 10⁻⁹ m≦t1<10⁻⁷ m, or 10⁻⁹ m≦t1<10⁻⁸ m.

The thickness t2 may be such that 10⁻¹⁰ m≦t1<10⁻⁸, 10⁻¹⁰ m≦t1<10⁻⁷ m, 10⁻¹⁰ m≦t1<10⁻⁶, 10⁻⁹ m≦t1<10⁻⁶ m, or 10⁻⁹ m≦t1<10⁻⁷ m, or 10⁻⁹ m≦t1<10⁻⁸ m.

The method may further comprise: (d) depositing a functional layer on the previously deposited layer, the functional layer being of nanometre scale or atomic layer thickness t3.

The thickness t3 may be such that 10⁻¹⁰ m≦t1<10⁻⁸, 10⁻¹⁰ m≦t1≦10⁻⁷ m, 10⁻¹⁰ m≦t1<10⁻⁶, 10⁻⁹ m≦t1<10⁻⁶ m, or 10⁻⁹ m≦t1<10⁻⁷ m, or 10⁻⁹ m≦t1<10⁻⁸ m.

The method may further comprise: performing steps (b) and (c) one or more further times, thereby forming a multilayer coating on the substrate such that alternate layers are deposited with different growth parameters, so as to have different structures and physical properties.

The method may further comprise: performing steps (b) to (d) one or more further times, thereby forming a multilayer coating on the substrate such that two layers are deposited with different growth parameters, so as to have different structures and physical properties, and successive sets of said two layers are separated by a functional layer.

In one embodiment, steps (b) and (c) are performed such that the first layer and the second layer are formed of the same element or compound. In another embodiment, steps (b) and (c) are performed such that the first layer and the second layer are formed of a different element or compound. For the first layer, the second layer, or both, the element is one of (1) Mo or (2) Ru or (3) Zr or (4) Nb, and the compound is a compound containing one of (1) Mo or (2) Ru or (3) Zr or (4) Nb.

The method may further comprise, during step (b) or (c), subjecting the materials of the first layer and/or second layer to reactive PVD deposition, whereby the materials react with a reactive gas to form reaction products in the first layer and/or second layer, respectively. Preferably, the reactive gas comprises N₂, O₂ or H₂, so as to form nitrides, oxides or hydride, respectively, as said reaction products.

Steps (b) and (c) may be performed such that the first layer or the second layer, but not both, is in (1) amorphous form or (2) nanocrystalline form. Further, steps (b) and/or (c) may be performed under stress compensating conditions. Also, steps (b) and/or (c) may comprise plasma deposition, sputtering, reactive sputtering, evaporation, reactive deposition or ion beam sputtering. In certain embodiments, step (b) and/or (c) include simultaneously nano-alloying the materials of the deposited layers, respectively.

The method may further include post-treating the deposited layers, thereby nano-alloying the materials of the deposited layers.

According to another aspect of the present invention there is provided a mirror for EUV applications, obtainable by the method of any of claims 1 to 18 of the appended claims.

According to another aspect of the present invention there is provided a mirror for EUV applications, comprising: a substrate; a deposited first layer on the substrate, the first layer being of nanometre or atomic level scale thickness t1; a second layer, deposited on the first layer, the second layer being of nanometre scale or atomic layer thickness t2; wherein the first and second layers are deposited with different growth parameters and physical properties, so as to have different structures; and wherein each layer forms, alone or with an adjacent layer, an EUV reflective element; thereby providing a mirror with a substantially stress free micrometer scale thickness coating resistant to erosion by fast debris particle from an EUV source

The mirror physical properties may comprise one or more of density, crystal structure and intrinsic stress.

The thickness t1 may be such that 10⁻¹⁰ m≦t1<10⁻⁸, 10⁻¹⁰ m≦t1<10⁻⁷ m, 10⁻¹⁰ m≦t1<10⁻⁶, 10⁻⁹ m≦t1<10⁻⁶ m, or 10⁻⁹ m≦t1<10⁻⁷ m, or 10⁻⁹ m≦t1<10⁻⁸ m.

The thickness t2 may be such that 10⁻¹⁰ m≦t1<10⁻⁸, 10⁻¹⁰ m≦t1<10⁻⁷ m, 10⁻¹¹ m≦t1<10⁻⁶, 10⁻⁹ m≦t1<10⁻⁶ m, or 10⁻⁹ m≦t1<10⁻⁷ m, or 10⁻⁹ m≦t1<10⁻⁸ m.

The mirror may further comprise: (d) a functional layer, deposited on the previously deposited layer, the functional layer being of nanometre scale or atomic layer thickness t3.

The thickness t3 may be such that 10⁻¹⁰ m≦t1<10⁻⁸, 10⁻¹⁰ m≦t1<10⁻⁷ m, 10⁻¹⁰ m≦t1<10⁻⁶, 10⁻⁹ m≦t1<10⁻⁶ m, or 10⁻⁹ m≦t1<10⁻⁷ m, or 10⁻⁹ m≦t1<10⁻⁸ m.

The mirror may comprise a multilayer coating on the substrate formed by multiple alternating ones of said first and second layers, such that alternate layers are deposited with different growth parameters, so as to have different structures.

The mirror may further comprise a multilayer coating on the substrate, comprising multiple successive formations of a second layer pattern, the second layer pattern comprising, in succession, said first and second layers and said functional layer, such that two layers are deposited with different growth parameters, so as to have different structures, and successive sets of said two layers are separated by the functional layer.

In one embodiment, the first layer and the second layer may be formed of the same element or compound.

In another embodiment, the first layer and the second layer are formed of a different element or compound.

For the first layer, the second, or both, the element may be one of (1) Mo or (2) Ru or (3) Zr or (4) Nb, and the compound may be a compound containing one of (1) Mo or (2) Ru or (3) Zr or (4) Nb.

The first layer and/or second layer may comprise materials that have been subjected to reactive PVD deposition, whereby the materials have reacted with a reactive gas to form reaction products in the first layer and/or second layer, respectively. Preferably, the reactive gas comprises N₂, O₂ or H₂, so as to form nitrides, oxides or hydride, respectively, as said reaction products.

In one embodiment, the first layer or the second layer, but not both, is in (1) amorphous form or (2) nanocrystalline form.

Preferably, the deposited layers are stress compensated or stress free.

The deposited layers may comprise plasma deposited, sputtered, reactively sputtered, evaporation (reactive evaporation) or ion beam sputtered deposited layers.

The deposited layers may comprise nano-alloyed layers.

According to another aspect of the present invention there is provided a collector optical system for EUV applications, for example EUV lithography, in which radiation is collected from a radiation source and directed to an image focus, comprising: one or more mirrors, the or each mirror being according to any of claims 14 to 26 of the appended claims and the or each mirror having at least first and second reflective surfaces, whereby, in use, radiation from the source undergoes successive grazing incidence reflections at said first and second reflective surfaces.

Preferably, the or each mirror is formed as an electroformed monolithic component, and wherein the first and second reflective surfaces are each provided on a respective one of two contiguous sections of the mirror. Preferably, a plurality of mirrors are provided in nested configuration.

According to another aspect of the present invention there is provided a EUV lithography system comprising: a radiation source, for example a LPP source, the collector optical system of any of claims 27 to 30 of the appended claims; an optical condenser; and a reflective mask.

According to another aspect of the present invention there is provided a multicomponent nano-structured stress free micrometer-thick coating having surface properties at the nanometer level that are preserved or improved during bombardment.

According to another aspect of the present invention there is provided a method of fabricating multicomponent nano-structured stress free micrometer-thick coating, comprising depositing a plurality of layers, each layer being of nanometre scale or atomic layer thickness, wherein consecutive layers are deposited with different growth parameters, so as to have different structures and physical properties; and wherein each layer forms, alone or with an adjacent layer, a reflective element, thereby forming a coating with a substantially stress free micrometer scale thickness that is resistant to erosion by fast debris particles.

According to another aspect of the present invention there is provided a multicomponent nano-structured stress free micrometer-thick coating having surface properties at the nanometer level that are preserved or improved during bombardment and being obtainable by the method of claim 42 of the appended claims.

An advantage of the invention is that the collection efficiency is improved and/or maximized.

A further advantage of the invention is that the lifetime and durability of the mirror is improved and/or maximized, and can be tailored to specific environmental conditions (e.g. impact of specific debris from light source).

Moreover in one form of the invention, there is formed nanostructured layer composed by one or more elements with the structure of multilayer with nanometre periodicity or nano-composite obtained by (co)deposition of one or more EUV reflective elements with alternating structure and growth parameters. This comprises (but is not limited to) multilayer of two elements (such as, for examples, Mo, Ru, Zr, Nb) with different nanostructure and interfaces (e.g. amorphous/amorphous, nanocrystalline/amorphous, etc.). Optionally, as part of the preparation method, there may be added reactive gases to deposition materials to form e.g. nitrides, hydrides, oxides of above mentioned element (but not limited to these). The entire coating is stress compensated (i.e. almost stress free or with a final stress adequate to obtain a stable optical layer with the substrate), with overall thickness of about several micrometers. The preferred method of deposition is physical, using plasma and ion assistance (sputtering, reactive sputtering, evaporation etc.) but the invention is not limited to these. The materials may be already nano-alloyed as the effect of the deposition process, or may be post-treated to reach the final homogeneous nano-structure.

One variant of the above is as follows. Rather than a plurality, a single element with modulated electronic and physical properties, obtained by periodic ion bombardment during growth to change film density and intrinsic stress, is formed. This stress compensated nano structured coating exhibits high average EUV reflectivity. Another variant of the above is as follows. A layer/coating is composed by two or more layers with nanometre scale or atomic layer thickness that will mix up by bombardment of extrinsic fast particles (debris from the EUV high power source) without altering/degrading the average stoichiometry.

Another variant of the above is as follows. A layer/coating is composed by two or more layers with nanometre scale or atomic layer thickness that will mix up by bombardment of extrinsic fast particles (debris from the EUV high power source) affecting the surface composition through preferential sputtering or segregation so that the mirror has a higher reflectivity, and/or higher lifetime during bombardment.

An advantage of the invention lies in enhanced durability: potential better resistance to hydrogen radicals.

A further advantage of the invention lies in increased thickness and mechanical stability of the mirror/coating.

A further advantage of the invention lies in enhanced durability: potential lower degradation of surface roughness and of reflectivity due to fast particles/ion bombardment.

A further advantage of the invention lies in enhanced durability: lower degradation of surface roughness and of reflectivity due to fast particles/ion bombardment achieved on the nanometer scale or atomic layer scale through the chemical reaction with the reactive debris particles (e.g. Sn).

A further advantage of depositing thick and stable multi-component materials is to allow surface compositional changes upon external treatments or during exposure (such as segregation, desorption, preferential sputtering) that will potentially enhance mirror performance and lifetime.

A further advantage of the invention is that final layer surface-topography is not dependent on substrate initial roughness because of the nanostructure and the deposition method, enabling direct deposition onto a plurality of different substrates with different surface roughness in the nanometer range.

In a further form of the invention, there is provided a coating comprising two or more of above nano-structured coatings separated by a functional layer or a set of thin layers eventually patterned, to be used as a marker or end-point material for cleaning (wet or RIE). The thickness of this layer is in the nanometre scale or atomic layer scale. This functional (spacer) layer can be insulating (e.g. silicon nitride or oxide) or metallic, depending on requested function.

Potential beneficial uses include:
Erosion diagnostics under service
New cleaning schemes, leading to predictability of lifetimes.
Investigating failure mechanisms

In a further form of the invention, there is provided nanostructured layer composed by one or more elements with the structure of multilayer with nanometre periodicity or nano-composite obtained by (co)deposition of one or more EUV reflective elements with alternating structure and growth parameters. This comprises (but is not limited to) multilayer of two or more elements (such as, for examples, Mo, Ru, Zr, Nb) with different nanostructure and interfaces (e.g. amorphous/amorphous, nanocrystalline/amorphous etc). The entire coating is stress compensated, with overall thickness of several micrometers. The preferred method of deposition is physical, using plasma and ion assistance (sputtering, evaporation, etc.), but is not limited to these. The materials may be already nano alloyed as the effect of the deposition process or may be post-treated, to reach the final nano-structure.

This coating is be structured so to have a great number of active interfaces where hydrogen is stored efficiently. This structure therefore slows down or inhibits hydrogen and hydrogen radical permeation through the coating. Preferably, molybdenum is used as one of constituents, due to its low affinity to hydrogen.

Advantageous include:
Durability: better resistance to hydrogen radicals for plasma cleaning protocols using atomic and molecular hydrogen.

The techniques according to the invention are particularly suited, but not limited to, HVM GIC technology.

Embodiments of the invention will now be described in detail, by way of example, with reference to the accompanying drawings, in which:

FIG. 1 (PRIOR ART) shows an example of a known EUV lithography system;

FIG. 2 (PRIOR ART) shows a ray diagram for the collector optics of the EUV lithography system of FIG. 1;

FIG. 3 (PRIOR ART) depicts in more detail a partial optical layout of a known type I Wolter nested collector (reference design) for EUV plasma sources;

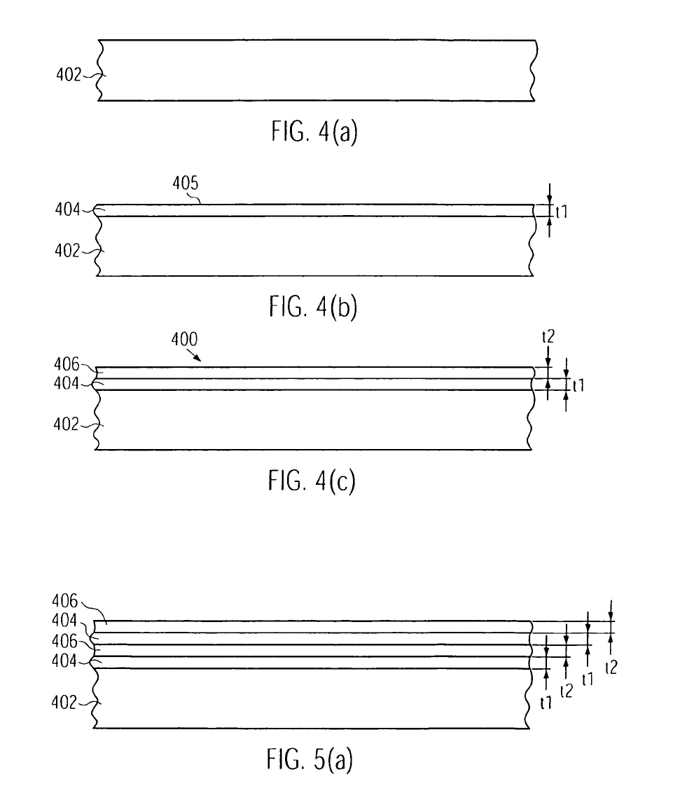

FIG. 4 illustrates a process, according to a first embodiment of the invention, for fabricating an EUV mirror;

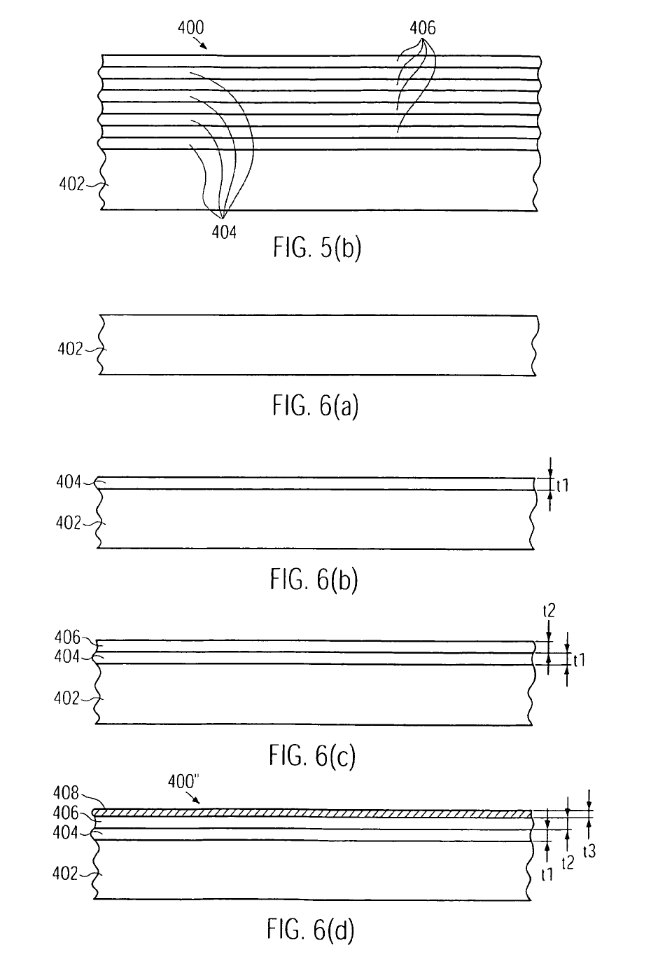

FIG. 5 shows a process, according to a second embodiment of the invention, for fabricating an EUV mirror;

FIG. 6 shows a process, according to a third embodiment of the invention, for fabricating an EUV mirror;

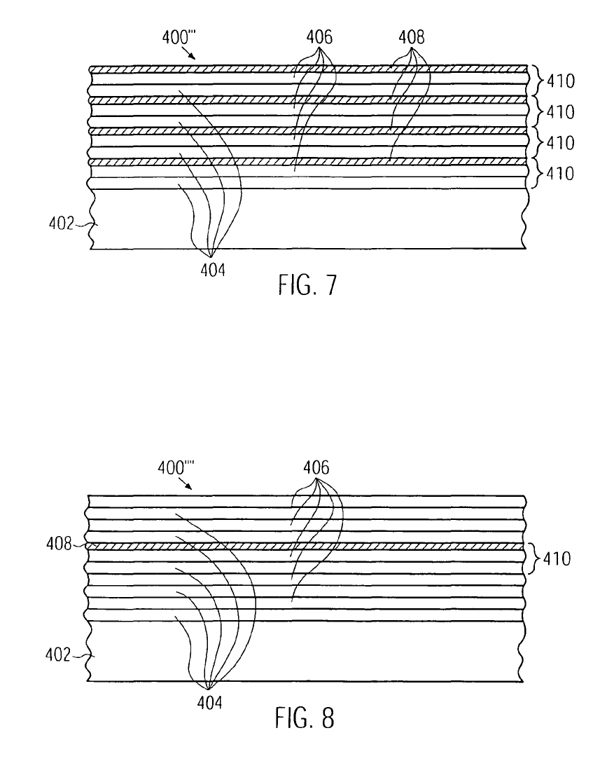

FIG. 7 shows a process, according to a fourth embodiment of the invention, for fabricating an EUV mirror; and

FIG. 8 shows a process, according to a fifth embodiment of the invention, for fabricating an EUV mirror.

In the description and drawings, like numerals are used to designate like elements. Unless indicated otherwise, any individual design features and components may be used in combination with any other design features and components disclosed herein.

In the illustrations of optical elements or systems herein, unless indicated otherwise, cylindrical symmetry around the optical axis is assumed; and references to an “image focus” are references to an image focus or an intermediate focus.

The terms “nanometre scale”, “atomic layer” and “micrometer scale”, and the like, as used herein, will be understood by persons skilled in the art. Where appropriate, “nanometre scale” may mean dimensions (e.g. thicknesses) approximately or exactly in the range 10⁻⁹ m to 10⁻⁶ m, or 10⁻⁹ m to 10⁻⁷ m, or 10⁻⁹ m to 10⁻⁸ m. By “atomic layer” and the like, as used herein, it is meant a layer whose thickness is in the range about 10⁻¹⁰ m to about 10⁻⁹ m. Where appropriate, “micrometer scale” may mean dimensions (e.g. thicknesses) approximately or exactly in the range about 10⁻⁶ m to about 10⁻⁵ m.

FIG. 4 illustrates a process, according to a first embodiment of the invention, for fabricating an EUV mirror 400. The substrate 402 for the mirror 400 is for example made of nickel, although persons skilled in the art will be aware that many other metal and non-metal materials may be used.

As seen in FIG. 4(b), a first layer 404 is formed on the surface of the substrate 402. The preferred method of deposition of first layer 404 is physical, using plasma and ion assistance (sputtering, reactive sputtering, evaporation, etc.), and the material deposited is suitably one of Mo, Ru, Zr, and Nb and suitable chemical compounds. The deposition of first layer 404 continues until a layer of substantially uniform thickness t1 is formed. Growth is then stopped. The thickness t1 is preferably nanometre or atomic layer scale. The deposition of first layer 404 is performed in stress compensating/eliminating conditions—so as to reduce or eliminate any internal stresses existing in the final mirror product—using techniques known to persons skilled in the art. The exposed surface 405 of the first layer may be treated (e.g. cleaning, polishing), prior to the next step, although this is not essential.

Next, a second layer 406 is formed on the surface 405 (FIG. 4(c)). This performed is the same manner as for the first layer, and one of Mo, Ru, Zr, Nb may be used (but not the same as for the first layer 404). The deposition of second layer 406 continues until a layer of substantially uniform thickness t2 is formed. Growth is then stopped. The thickness t2 is preferably nanometre or atomic layer scale. Also, first and second layers 404, 406 are formed so as to have different nanostructure and interfaces (e.g. amorphous/amorphous, nanocrystalline/amorphous, etc.).

FIG. 5 shows a process, according to a second embodiment of the invention, for fabricating an EUV mirror 402′. This is the same as the previous embodiment, except as described below.

In this embodiment, starting from the product illustrated in FIG. 4(c), deposition steps corresponding substantially to the steps for deposition the first and second layers 404, 406 are repeated, thus producing a coating having 4 layers (see FIG. 5(a)). These steps may be repeated further, so as to build up layers and improve mechanical and/or optical properties. For example, repeating these steps a further two times produces the multilayer configuration illustrated in FIG. 5(b). Here, there are alternating layers 404, 406 having different nanostructure and interfaces.

FIG. 6 shows a process, according to a third embodiment of the invention, for fabricating an EUV mirror 400″. This is the same as the first embodiment (i.e. the steps illustrated in FIGS. 6(a) to (c) are identical), except as described below. After formation of the second layer 406, a functional layer 408 is formed. The functional layer 408 may comprise a single layer or may itself comprise a set of thin layers that are eventually patterned, to be used as a marker or end-point material for cleaning (wet or RIE). The thickness of this layer is in the nanometre or atomic layer scale. This functional layer 408 may be insulating (e.g. silicon nitride or oxide) or metallic, depending on desired function.

FIG. 7 shows a process, according to a fourth embodiment of the invention, for fabricating an EUV mirror 400′″. This is the same as the previous embodiment, except as described below.

In this embodiment, starting from the product illustrated in FIG. 6(b), deposition steps corresponding substantially to the steps for deposition the first and second layers 404, 406 and of the functional layer 408, are repeated one or more times (here three), thus producing a multilayer coating having 9 layers (see FIG. 7). This building up of layers may improve mechanical and/or optical properties. The result is a four-times repeated layer pattern 410, the layer pattern 410 comprising, in sequence, the first layer 404, the second layer, 406 and the functional layer 408 (as described above).

FIG. 8 shows a process, according to a fifth embodiment of the invention, for fabricating an EUV mirror 400′″. This is the same as the previous embodiment, except as described below. It will be appreciated by persons skilled in the art that regular repetition of the layer pattern 410 is not required. For example, there may be a number (here two) of repetitions of deposition of the first and second layers 404, 406, followed by deposition of the layer pattern 410, followed by a number (here two) of repetitions of deposition of the first and second layers 404, 406. It will be understood that a multitude of permutations and variations may be implemented.

1. A method of fabricating a grazing incidence mirror for reflecting extreme ultraviolet (EUV) radiation from an EUV radiation source that emits fast debris particles, comprising:
(a) providing a mirror substrate;
(b) depositing on the substrate a first layer nanometre scale or atomic layer atomic-layer scale and having a thickness t1;
(c) depositing on the first layer a second layer of nanometre scale or atomic-layer scale and having a thickness t2;
wherein the first and second layers are deposited with different growth parameters, so as to have different structures and physical properties; and
performing (b) and (c) a plurality of times under stress-compensating conditions, thereby forming a substantially stress-free, micrometer-scale-thickness reflective coating that is resistant to erosion by the fast debris particles from the EUV source.

2. The method of claim 1, wherein the physical properties comprise one or more of density, crystal structure and intrinsic stress.

3-4. (canceled)

5. The method of claim 1, further comprising:
(d) depositing a functional layer on a previously deposited first or second layer, the functional layer being of nanometre scale or atomic-layer scale and having a thickness t3.

6-7. (canceled)

8. The method of claim 5, further comprising:
performing (d) one or more further times so as to have successive sets of said first and second layers separated by a functional layer.

9. The method of claim 1, wherein the first layer and the second layer each include at least one of Mo, Ru, Zr and Nb.

10-11. (canceled)

12. The method of claim 1, further comprising, during step (b) or (c), subjecting the first layer and/or second layer to physical vapor deposition (PVD), whereby the materials react with a reactive gas to form nitride, oxide or hydride reaction products in the first layer and/or second layer, respectively.

13. (canceled)

14. The method of claim 1, including performing (b) and (c) such that the first layer or the second layer, but not both, is either amorphous or nanocrystalline.

15. (canceled)

16. The method of claim 1, further including nano-alloying the first and second layers.

17-18. (canceled)

19. A grazing incidence collector mirror for use with an extreme ultraviolet (EUV) source that emits fast debris particles, comprising:
a mirror substrate;
a deposited first layer on the substrate, the first layer being of nanometer or atomic layer scale and having a thickness t1;
a second layer, deposited on the first layer, the second layer being of nanometre or atomic-layer scale and having a thickness t2;
wherein the first and second layers are deposited with different growth parameters and physical properties, so as to have different structures and to be substantially stress-compensated; and
wherein the mirror comprises a number of further deposited first and second layers, thereby providing a mirror with a substantially stress-free, micrometer-scale-thickness reflective coating that is resistant to erosion by the fast debris particles from the EUV source

20. The mirror of claim 19, wherein the physical properties comprise one or more of density, crystal structure and intrinsic stress.

21-22. (canceled)

23. The mirror of claim 19, further comprising:
(d) a functional layer deposited on a previously deposited first or second layer and having a nanometre or atomic layer scale and a thickness t3.

24-25. (canceled)

26. The mirror of claim 23, further comprising:
multiple layer patterns comprising, in succession, said first and second layers and said functional layer, such that two layers are deposited with different growth parameters, so as to have different structures, with successive sets of said two layers separated by the corresponding functional layer.

27-28. (canceled)

29. The mirror of claim 19, wherein the first and second layers each include one of Mo, Ru, Zr and Nb.

30-31. (canceled)

32. The mirror of claim 19, wherein the first layer or the second layer, but not both, is amorphous or nanocrystalline.

33. (canceled)

34. The mirror of claim 19, wherein the deposited layers are nano-alloyed.

35. An EUV collector optical system, comprising:
one or more mirrors according to claim 19, the or each mirror having at least first and second reflective surfaces each configured to reflect the EUV radiation at successive grazing incidence angles.

36-46. (canceled)

47. An EUV lithography system for patterning a wafer comprising:
the EUV collector optical system of claim 35 configured to collected EUV radiation from the EUV radiation source;
an optical condenser configured to condense EUV radiation received from the EUV collector optical system; and
a reflective mask having a pattern and arranged to receive EUV radiation from the optical condenser and;
a projection optics configured to receive reflected EUV radiation from the reflective mask and form the reflective-mask pattern on the wafer.

48-50. (canceled)

51. method of fabricating a grazing incidence collector mirror for use with an extreme ultraviolet (EUV) radiation source that emits fast debris particles, comprising:
(a) providing a substrate;
(b) depositing on the substrate a layer having micrometer-scale thickness and consisting of a single element or compound, including forming the thick layer by
forming a plurality of sublayers of nanometre or atomic layer thickness, including subjecting
successive sublayers to alternating or periodic treatment during deposition thereof so that the successive sublayers have different structures and physical properties; and
wherein (b) is carried out under stress-compensating conditions, so that the micrometer-scale layer is reflective and substantially stress-free while being resistant to erosion by the fast debris particles from the EUV radiation source.

52. The method of claim 51, wherein said stress-compensating conditions include ion bombardment.

53. The method of claim 51, wherein the physical properties comprise one or more of density, crystal structure and intrinsic stress.
